(19) United States
(12) Patent Application Publication
(10) Pub. No.: US 2025/0286149 A1
(43) Pub. Date: Sep. 11, 2025

(54) BATTERIES AND BATTERY MANUFACTURING TECHNIQUES

(71) Applicant: Power 3D, Inc., Pittsburgh, PA (US)

(72) Inventors: Justin Allen Payne, Saxonburg, PA (US); Peter Neal Scott, Dexter, MI (US); Rahul P. Panat, Sewickley, PA (US)

(21) Appl. No.: 19/072,592

(22) Filed: Mar. 6, 2025

Related U.S. Application Data
(60) Provisional application No. 63/562,997, filed on Mar. 8, 2024.

(51) Int. Cl. H01M 10/0585; H01M 4/02; H01M 4/04; H01M 4/131; H01M 4/133; H01M 4/136; H01M 4/1391; H01M 4/1393; H01M 4/1397; H01M 4/66; H01M 50/46; H01M 50/536

(52) U.S. Cl. CPC H01M 10/0585; H01M 4/0411; H01M 4/0423; H01M 4/131; H01M 4/133; H01M 4/136; H01M 4/1391; H01M 4/1393; H01M 4/1397; H01M 4/661; H01M 4/667; H01M 50/46; H01M 50/536; H01M 2004/027; H01M 2004/028

(57) ABSTRACT

A method comprising forming a cathode wafer, forming an anode wafer, sectioning the cathode wafer into a plurality of cathode dies, and sectioning the anode wafer into a plurality of anode dies is disclosed. Forming the cathode wafer comprises layering a first plurality of films and 3D printing a cathode lattice. Forming the anode wafer comprises layering a second plurality of films and applying an anode layer. The plurality of cathode dies comprises a first cathode die and the plurality of anode dies comprises a first anode die. A pair of dies comprises the first cathode die and the first anode die. The method further comprises assembling a battery with the pair of dies.

### CROSS-REFERENCE TO RELATED APPLICATION

This application claims the benefit under 35 U.S.C. § 119(e) of U.S. Provisional Patent Application Ser. No. 63/562,997, titled BATTERIES AND BATTERY MANUFACTURING TECHNIQUES, filed Mar. 8, 2024, the entire disclosure of which is hereby incorporated by reference herein.

### SUMMARY

In various aspects, a method comprising forming a cathode wafer and forming an anode wafer is disclosed. Forming the cathode wafer comprises layering a first plurality of films, positioning a first interposer layer over the first plurality of films, and 3D printing a cathode lattice adjacent to the first interposer layer. Forming the anode wafer comprises layering a second plurality of films, positioning a second interposer layer over the second plurality of films, and applying an anode layer adjacent to the second interposer layer. The method further comprises sectioning the cathode wafer into a plurality of cathode dies comprising a first cathode die. The method further comprises sectioning the anode wafer into a plurality of anode dies comprising a first anode die. The method further comprises attaching a first conductor to the first cathode die, attaching a second conductor to the first anode die, applying a separator layer to at least one of the cathode lattice of the first cathode die and the anode layer of the first anode die, positioning the separator layer between the cathode lattice and the anode layer, and bonding the first anode die to the first cathode die to form a battery comprising the separator layer positioned between the cathode lattice and the anode layer.

In various aspects, a method comprising forming a cathode wafer and forming an anode wafer is disclosed. Forming the cathode wafer comprises layering a first plurality of films and 3D printing a cathode lattice. Forming the anode wafer comprises layering a second plurality of films and applying an anode layer. The method further comprises sectioning the cathode wafer into a plurality of cathode dies comprising a first cathode die. The method further comprises sectioning the anode wafer into a plurality of anode dies comprising a first anode die. A pair of dies comprises the first cathode die and the first anode die. The method further comprises assembling a battery with the pair of dies.

In various aspects, a battery comprising a cathode portion, an anode portion, an interposer layer, and a separator layer is disclosed. The cathode portion comprises a first plurality of film layers, a cathode layer, and a first conductor. The cathode layer comprises a micro-lattice. The anode portion comprises a second plurality of film layers, an anode layer, and a second conductor. The interposer layer extends between the first plurality of film layers and the second plurality of film layers and around the cathode layer and the anode layer. The separator layer is positioned between the cathode layer and the anode layer.

### BRIEF DESCRIPTION OF THE FIGURES

The features of various aspects are set forth with particularity in the appended claims. The various aspects, however, both as to organization and methods of operation, together with further objects and advantages thereof, may best be understood by reference to the following description, taken in conjunction with the accompanying drawings as follows:

FIG. 1 is a plan view of a cathode wafer base, depicting a first film layer attached to a first support substrate, in accordance with at least one aspect of the present disclosure.

FIG. 2 is a plan view of an anode wafer base, depicting a second film layer attached to a second support substrate, in accordance with at least one aspect of the present disclosure.

FIG. 3 is a plan view of a cathode die of the cathode wafer base of FIG. 1, in accordance with at least one aspect of the present disclosure.

FIG. 4 is a plan view of an anode die of the anode wafer base of FIG. 2, in accordance with at least one aspect of the present disclosure.

FIG. 5 is a cross section view of FIG. 3 taken along line 5-5 in FIG. 3, in accordance with at least one aspect of the present disclosure.

FIG. 6 is a cross section view of FIG. 4 taken along line 6-6 in FIG. 4, in accordance with at least one aspect of the present disclosure.

FIG. 7 is a plan view of the cathode wafer base of FIG. 1, further depicting a cathode current collector film deposited onto the cathode wafer base, in accordance with at least one aspect of the present disclosure.

FIG. 8 is a plan view of the anode wafer base of FIG. 2, further depicting an anode current collector film deposited onto the anode wafer base, in accordance with at least one aspect of the present disclosure.

FIG. 9 is a plan view of a cathode die of the cathode wafer base of FIG. 7, in accordance with at least one aspect of the present disclosure.

FIG. 10 is a plan view of an anode die of the anode wafer base of FIG. 8, in accordance with at least one aspect of the present disclosure.

FIG. 11 is a cross section view of FIG. 9 taken along line 11-11 in FIG. 9, in accordance with at least one aspect of the present disclosure.

FIG. 12 is a cross section view of FIG. 10 taken along line 12-12 in FIG. 10, in accordance with at least one aspect of the present disclosure.

FIG. 13 is a plan view of the cathode wafer base of FIG. 7, further depicting an interposer layer applied to the cathode wafer base, in accordance with at least one aspect of the present disclosure.

FIG. 14 is a plan view of the anode wafer base of FIG. 8, depicting an interposer layer applied to the anode wafer base, in accordance with at least one aspect of the present disclosure.

FIG. 15 is a plan view of a cathode die of the cathode wafer base of FIG. 13, in accordance with at least one aspect of the present disclosure.

FIG. 16 is a plan view of an anode die of the anode wafer base of FIG. 14, in accordance with at least one aspect of the present disclosure.

FIG. 17 is a cross section view of FIG. 15 taken along line 17-17 in FIG. 15, in accordance with at least one aspect of the present disclosure.

FIG. 18 is a cross section view of FIG. 16 taken along line 18-18 in FIG. 16, in accordance with at least one aspect of the present disclosure.

FIG. 19 is a plan view of a cathode wafer that includes the cathode wafer base of FIG. 13 and a cathode lattice that has been additively manufactured (e.g., 3D printed) onto the cathode wafer base, in accordance with at least one aspect of the present disclosure.

FIG. 20 is a plan view of an anode wafer that includes the anode wafer base of FIG. 14 and an anode layer that has been applied to the anode wafer base, in accordance with at least one aspect of the present disclosure.

FIG. 21 is a plan view of a cathode die of the cathode wafer of FIG. 19, in accordance with at least one aspect of the present disclosure.

FIG. 22 is a plan view of an anode die of the anode wafer of FIG. 20, in accordance with at least one aspect of the present disclosure.

FIG. 23 is a cross section view of FIG. 21 taken along line 23-23 in FIG. 21, in accordance with at least one aspect of the present disclosure.

FIG. 24 is a cross section view of FIG. 22 taken along line 24-24 in FIG. 22, in accordance with at least one aspect of the present disclosure.

FIG. 25 is a plan view of the cathode wafer of FIG. 19, depicting dicing tape applied to the cathode wafer and the cathode wafer sectioned into a plurality of individual cathode dies, in accordance with at least one aspect of the present disclosure.

FIG. 26 is a plan view of the anode wafer of FIG. 20, depicting dicing tape applied to the anode wafer and the anode wafer sectioned into a plurality of individual anode dies, in accordance with at least one aspect of the present disclosure.

FIG. 27 is a plan view of one of the individual cathode dies of FIG. 25, depicting a conductor attached to a tab of the individual cathode die, in accordance with at least one aspect of the present disclosure.

FIG. 28 is a plan view of one of the individual anode dies of FIG. 26, depicting a conductor attached to a tab of the individual anode die, in accordance with at least one aspect of the present disclosure.

FIG. 29 is a cross section view of FIG. 27 taken along line 29-29 in FIG. 27, in accordance with at least one aspect of the present disclosure.

FIG. 30 is a cross section view of FIG. 28 taken along line 30-30 in FIG. 28, in accordance with at least one aspect of the present disclosure.

FIG. 31 is a plan view of the individual cathode die of FIG. 27, depicting the cathode layer of the individual cathode die wetted with an electrolyte solution, in accordance with at least one aspect of the present disclosure.

FIG. 32 is a plan view of the individual anode die of FIG. 28, depicting the anode layer of the individual anode die wetted with an electrolyte solution and a separator film applied to the anode layer of the individual anode die, in accordance with at least one aspect of the present disclosure.

FIG. 33 is a cross section view of FIG. 25 taken along line 27-27 in FIG. 25, in accordance with at least one aspect of the present disclosure.

FIG. 34 is a cross section view of FIG. 26 taken along line 28-28 in FIG. 26, in accordance with at least one aspect of the present disclosure.

FIG. 35 is a plan view of the individual cathode die of FIG. 31 and the individual anode die of FIG. 32, depicting the direction in which the individual anode die may be rotated onto the individual cathode die, in accordance with at least one aspect of the present disclosure.

FIG. 36 is a plan view of a battery assembled from the individual cathode die and the individual anode die of FIG. 35, depicted the anode die and the cathode die bonded together to form the battery, in accordance with at least one aspect of the present disclosure.

FIG. 37 is a cross section view of the battery of FIG. 36 taken along line 37-37 in FIG. 36, in accordance with at least one aspect of the present disclosure.

FIG. 38 is an enlarged cross section view of FIG. 37, in accordance with at least one aspect of the present disclosure.

FIG. 39 is a flow chart depicting a method of manufacturing a battery, in accordance with at least one aspect of the present disclosure.

### DETAILED DESCRIPTION

Before explaining various aspects of the manufacturing method, systems, and batteries thereof in detail, it should be noted that the illustrative examples are not limited in application or use to the details of construction and arrangement of parts illustrated in the accompanying drawings and description. The illustrative examples may be implemented or incorporated in other aspects, variations, and modifications, and may be practiced or carried out in various ways. Further, unless otherwise indicated, the terms and expressions employed herein have been chosen for the purpose of describing the illustrative examples for the convenience of the reader and are not for the purpose of limitation thereof. Also, it will be appreciated that one or more of the following-described aspects, expressions of aspects, and/or examples, can be combined with any one or more of the other following-described aspects, expressions of aspects and/or examples.

In general, fabricating a plurality of micro-batteries in batches at as many steps of the process as possible may reduce the overall cost of manufacture when scaling for production and commercialization thereof and/or increase the reliability of the batteries and yield of the manufacturing process. Additionally, maximizing the number of batteries processed during one aerosol jet printer run could reduce the cost contribution of one of the rate-limiting steps in the fabrication process. In various aspects, cathode and anode wafers can be processed using batch semi-conductor processing techniques in combination with subsequent additive manufacturing/3-D printing and/or manual processing techniques for individual battery die. Manual processing techniques may be suitable for later fabrication steps, such as external conductor wire attachment, electrolyte wetting, separator film lamination, and/or final battery sealing, for example. In certain instances, battery processing techniques which may be typically performed manually may be automated to aid in scaling the manufacturing process.

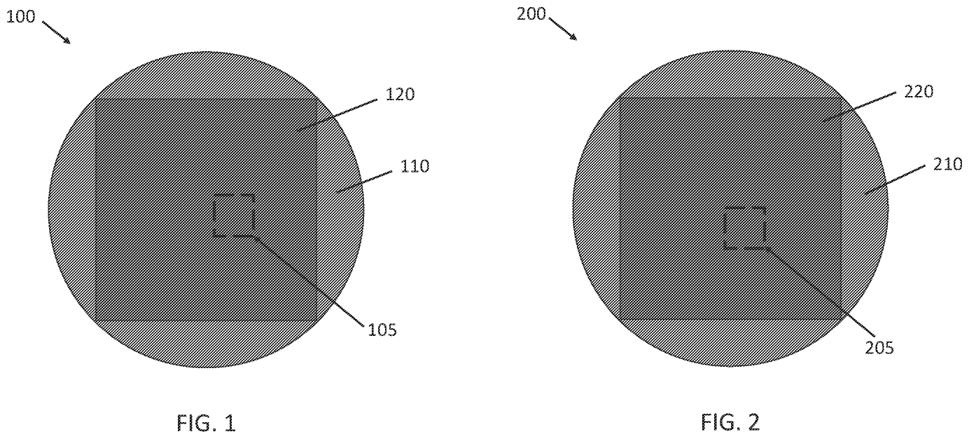

FIG. 1 illustrates a cathode wafer base 100 comprising a first support substrate 110 and a first film layer 120 placed onto the first support substrate 110. In at least one aspect, the first film layer 120 is laminated onto the first support substrate 110. In at least one aspect, the first film layer 120 is 100 μm thick and measured 70 mm wide by 70 mm long. In at least one aspect, the first film layer 120 comprises biaxially oriented polyethylene terephthalate (BoPET). In at least one aspect, the first film layer 120 comprises aluminum. In at least one aspect, the first film layer 120 comprises a layer of aluminum sandwiched between two BoPET layers. In at least one aspect, the first film layer 120 comprises a polyimide film such as Kapton. In at least one aspect, the first support substrate 110 comprises a silicon wafer. In at least one aspect, the silicon wafer is 100 mm in diameter and 500 μm thick.

FIG. 2 illustrates an anode wafer base 200 comprising a second support substrate 210 and a second film layer 220 placed onto the second support substrate 210. In at least one aspect, the second film layer 220 is 100 μm thick and measures 70 mm wide by 70 mm long. In at least one aspect, the second film layer 220 is laminated onto the second support substrate 210. In at least one aspect, the second film layer 220 comprises biaxially oriented polyethylene terephthalate (BoPET). In at least one aspect, the second film layer 220 comprises aluminum. In at least one aspect, the second film layer 220 comprises a layer of aluminum sandwiched between two BoPET layers. In at least one aspect, the second film layer 220 comprises a polyimide film such as Kapton. In at least one aspect, the second support substrate 210 comprises a silicon wafer. In at least one aspect, the silicon wafer is 100 mm in diameter and 500 μm thick. In at least one aspect, the silicon wafer is greater than or equal to 100 mm and less than or equal to 500 mm. In at least one aspect, the silicon wafer is greater than 500 mm. Referring to FIGS. 1 and 2, the first and second support substrates 110, 210 are the same. In other instances, the first and second support substrates 110, 210 can be different. Referring still to FIGS. 1 and 2, the first and second film layers 120, 220 are the same. In other instances, the first and second film layers 120, 220 can be different.

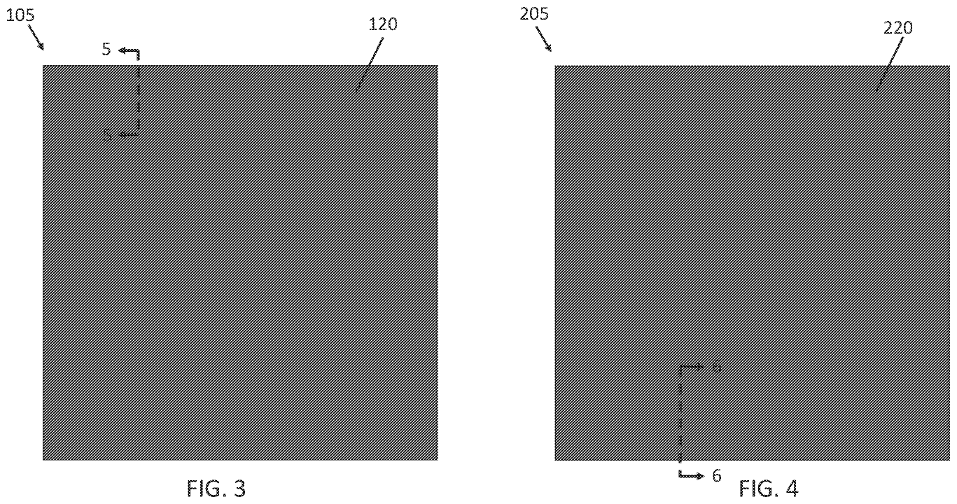

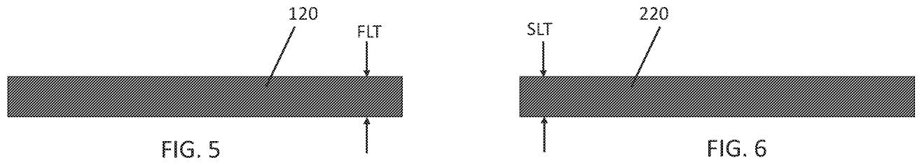

FIG. 3 illustrates a cathode die 105 of the cathode wafer base 100 of FIG. 1; FIG. 4 illustrates an anode die 205 of the anode base 200 of FIG. 2. As discussed in greater detail herein, once a cathode wafer and an anode wafer are complete, the cathode wafer may be sectioned (e.g., diced) into a plurality of cathode dies (e.g., cathode unit cells) and the anode wafer may be sectioned (e.g., diced) into a plurality of individual anode dies (e.g. anode unit cells). Sectioning can comprise die singulation, or wafer dicing, for example. FIGS. 3 and 4 are representative of what the cathode die 105 and the anode die 205 would look like if sectioned from their respective wafer bases 100, 200 at this stage of manufacture.

FIG. 5 is a cross section view of FIG. 3 taken along line 5-5 in FIG. 3. FIG. 5 illustrates a portion of the cathode die 105 comprising the first film layer 120. For clarity, the first support substrate 110 is not shown in FIG. 5. In at least one aspect, the first film layer 120 defines a first layer thickness FLT. In at least one aspect, the first layer thickness FLT is approximately 100 μm.

FIG. 6 is a cross section view of FIG. 4 taken along line 6-6 in FIG. 4. FIG. 6 illustrates a portion of the anode die 205 comprising the second film layer 220. For clarity, the first support substrate 210 Is not shown in FIG. 6. In at least one aspect, the second film layer 220 defines a second layer thickness SLT. In at least one aspect, the second layer thickness SLT is approximately 100 μm. Referring to FIGS. 5 and 6, the first layer thickness FLT and the second layer thickness SLT are equal. In other instances, the thicknesses may be different.

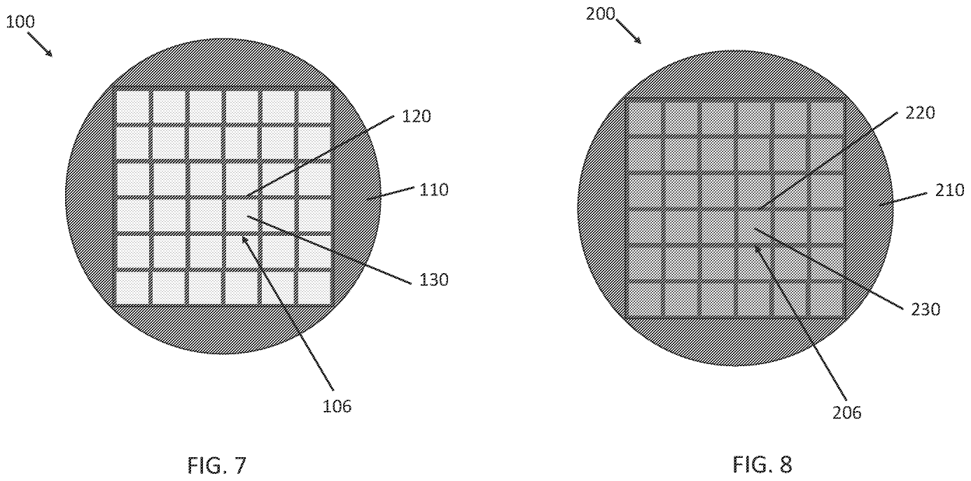

FIG. 7 illustrates the cathode wafer base 100 of FIG. 1 further comprising a cathode current collector film 130 deposited onto the first film layer 120. In at least one aspect, the cathode current collector film 130 comprises a metal film. In at least one aspect, the cathode current collector film 130 comprises aluminum (Al). In at least one aspect, the cathode current collector film 130 comprises chromium (Cr). In at least one aspect, the cathode current collector film 130 comprises copper (Cu). In at least one aspect, the cathode current collector film 130 is applied to the first film layer 120 using e-beam evaporation. In at least one aspect, the cathode current collector film 130 is applied to the first film layer 120 using physical vapor deposition (PVD). In at least one aspect, the cathode current collector film 130 is applied to the first film layer 120 in an array which demarcates the individual cathode dies of the cathode wafer base 100. For example, FIG. 7 illustrates the cathode current collector film 130 applied to the first film layer 120 such that thirty-six individual squares are formed in an array over the first film layer 120.

FIG. 8 illustrates the anode wafer base 200 of FIG. 2 further comprising an anode current collector film 230 deposited onto the second film layer 220. In at least one aspect, the anode current collector film 230 comprises a metal film. In at least one aspect, the anode current collector film 230 comprises copper (Cu). In at least one aspect, the anode current collector film 230 comprises aluminum (Al). In at least one aspect, the anode current collector film 230 comprises chromium (Cr). In at least one aspect, the anode current collector film 230 is applied to the second film layer 220 using e-beam evaporation. In at least one aspect, the anode current collector film 230 is applied to the second film layer 220 using physical vapor deposition (PVD). In at least one aspect, the anode current collector film 230 is applied to the second film layer 220 in an array which demarcates the individual anode dies of the anode wafer base 200. For example, FIG. 8 illustrates the anode current collector film 230 applied to the second film layer 220 such that thirty-six individual squares are formed in an array over the second film layer 220.

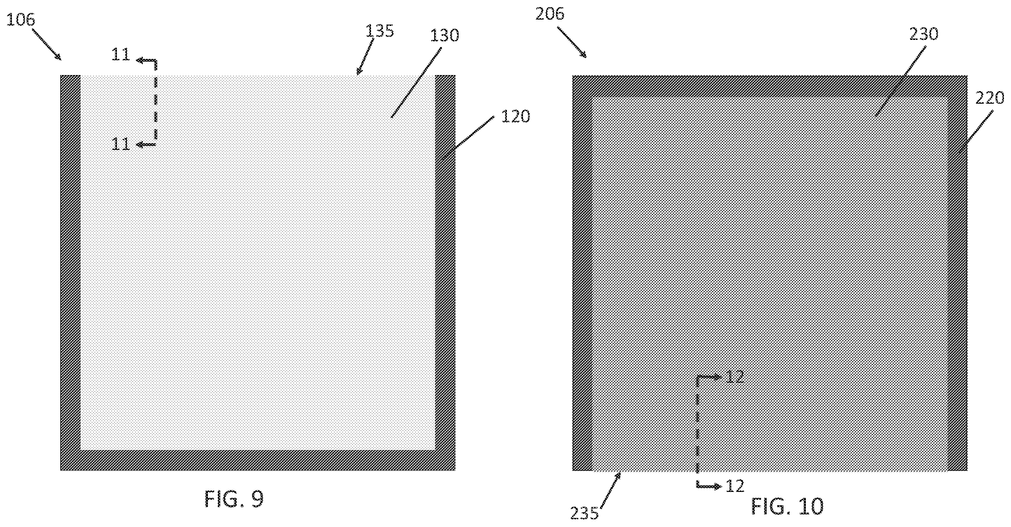

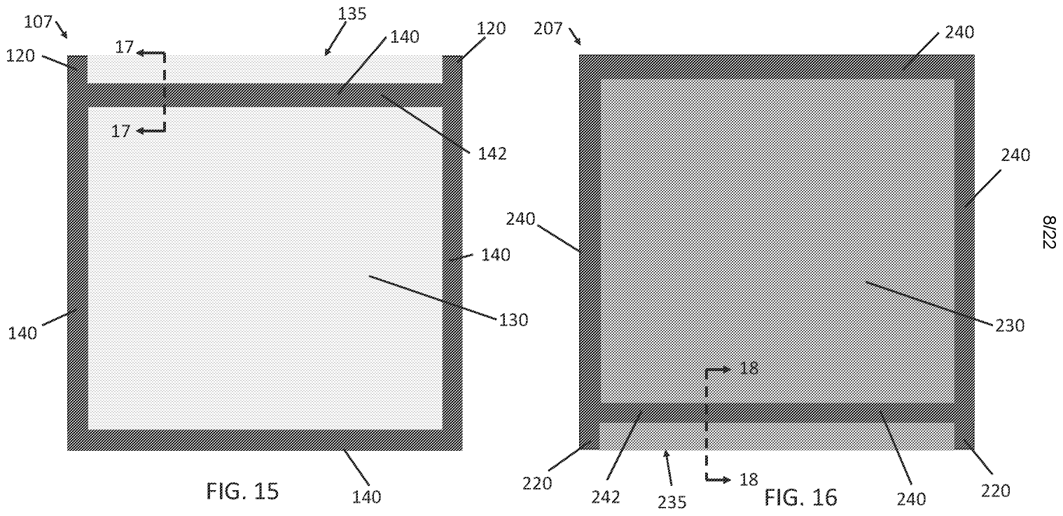

FIG. 9 illustrates a cathode die 106 of the cathode wafer base 100 of FIG. 7 and FIG. 10 illustrates an anode die 206 of the anode wafer base 200 of FIG. 8. FIGS. 9 and 10 are representative of what the cathode die 106 and the anode die 206 would look like if sectioned from their respective wafer bases 100, 200, at this state of manufacture. In at least one aspect, after sectioning, at least a portion of the cathode current collector film 130 is exposed on one side to form a first tab 135 (e.g. FIG. 15). In at least one aspect, after sectioning, at least a portion of the anode current collector film 230 is exposed on one side to form a second tab 235 (e.g. FIG. 16).

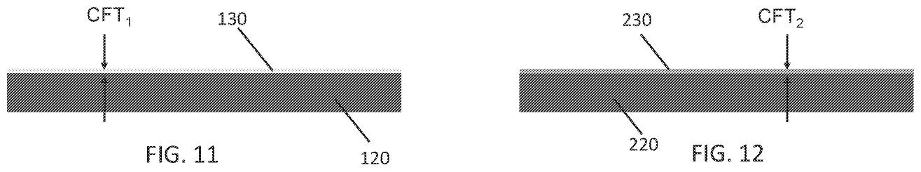

FIG. 11 is a cross section view of FIG. 9 taken along line 11-11 in FIG. 9. FIG. 11 illustrates a portion of the cathode die 106 comprising the first film layer 120 and the cathode current collector film 130. In at least one aspect, the cathode current collector film 130 defines a first current film thickness CFT₁. In at least one aspect, the first current film thickness CFT₁ is approximately 1 μm.

FIG. 12 is a cross section view of FIG. 10 taken along line 12-12 in FIG. 10. FIG. 12 illustrates a portion of the anode die 205 comprising the second film layer 220 and the anode current collector film 230. In at least one aspect, the anode current collector film 230 defines a second current film thickness CFT₂. In at least one aspect, the second current film thickness CFT₂ is approximately 5 μm. Referring to FIGS. 11 and 12, the first current film thickness CFT₁ and the second current film thickness CFT₂ are different materials and different thicknesses. In various instances, the relative thicknesses can depend on the material thereof, among other factors.

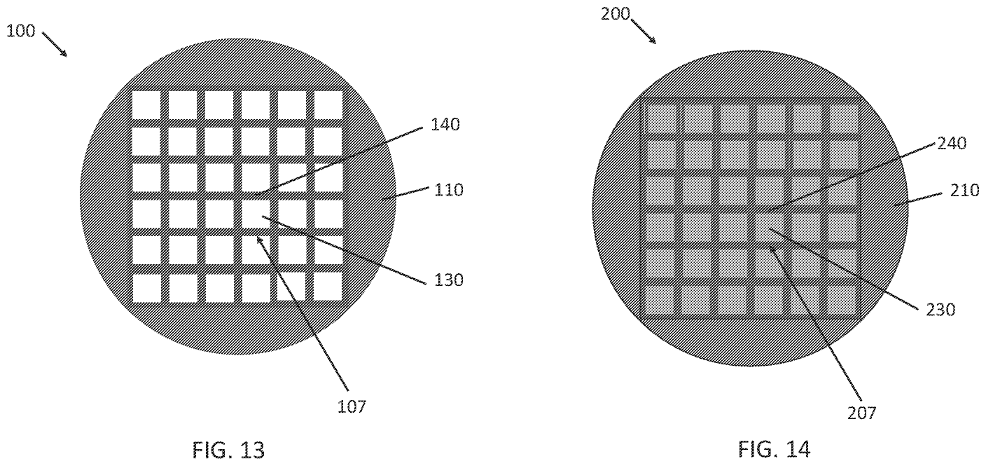

FIG. 13 illustrates the cathode wafer base 100 of FIG. 7, further comprising a first interposer layer 140 applied to the cathode current collector film 130. Further, FIG. 14 illustrates the anode wafer base 200 of FIG. 8, further comprising a second interposer layer 240 applied to the anode current collector film 230. In at least one aspect, the first interposer layer 140 and the second interposer layer 240 are applied in 250 μm wide adhesion regions. In at least one aspect, the first interposer layer 140 and the second interposer layer 240 comprise a pre-cut biaxially oriented polyethylene terephthalate (BoPET) washer. In other aspects, the first interposer layer 140 and the second interposer layer 240 comprise a bond pre-cut MYLAR washer. In at least one aspect, the first interposer layer 140 and the second interposer layer 240 are thermally cured. In at least one aspect, the thermal cure is performed at 165° C. In other aspects, the thermal cure can occur at a suitable temperature less than or more than 165° C. The thermal cure temperature can depend on the material, for example.

FIG. 15 illustrates a cathode die 107 of the cathode wafer base 100 of FIG. 13. The cathode die 107 comprises the first interposer layer 140 applied to the cathode current collector film 130. Further, FIG. 16 illustrates an anode die 207 of the anode wafer base 200 of FIG. 14. The anode die 207 comprises the second interposer layer 240 applied to the anode current collector film 230. FIGS. 15 and 16 are representative of what the cathode die 107 and the anode die 207 would look if sectioned from their respective wafer bases 100, 200 at this stage of manufacture. As can be seen in FIG. 15, the first interposer layer 140 defines a generally or substantially square shape. Further, a first interposer wall 142 of the first interposer layer 140 separates the first tab 135 from the remainder of the cathode current collector film 130. Similarly, as can be seen in FIG. 16, the second interposer layer 240 defines a generally or substantially square shape. Further, a second interposer wall 242 of the second interposer layer 240 separates the second tab 235 from the remainder of the anode current collector film 230.

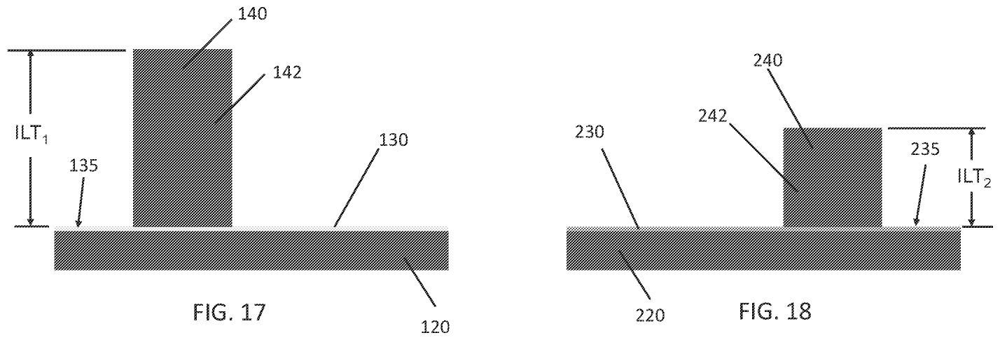

FIG. 17 is a cross section view of FIG. 15 taken along line 17-17 in FIG. 15. FIG. 17 illustrates a portion of the cathode die 107 comprising the first film layer 120, the cathode current collector film 130, and the first interposer layer 140. In at least one aspect, the first interposer layer 140 defines a first interposer layer thickness ILT₁. In at least one aspect, the first interposer layer thickness ILT₁ is approximately 450 μm.

FIG. 18 is a cross section view of FIG. 16 taken along line 18-18 in FIG. 12. FIG. 18 illustrates a portion of the anode die 207 comprising the second film layer 220, the anode current collector film 230, and the second interposer layer 240. In at least one aspect, the second interposer layer 240 defines a second interposer layer thickness ILT₂. In at least one aspect, the second interposer layer thickness ILT₂ is approximately 250 μm. Referring to FIGS. 17 and 18, the first and second interposer layers 140, 240 are the same material and the first interposer layer thickness ILT₁ is different than the second interposer layer thickness ILT₂. The relative thicknesses can depend on the energy storing capabilities of the anode and cathode, for example, as further described herein. In other instances, the first interposer layer thickness ILT₁ and the second interposer layer thickness ILT₂ may be the same.

Further to the above, in various aspects, a first photo-definable polyimide film may be positioned between the cathode current collector film 130 and the first interposer layer 140. Further, in various aspects, a second photo-definable polyimide film may be positioned between the anode current collector film 230 and the second interposer layer 240.

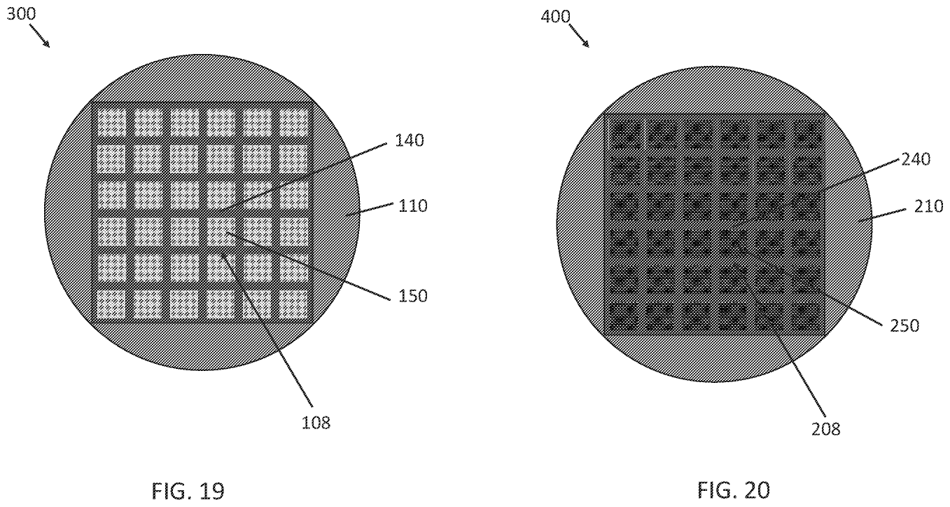

FIG. 19 illustrates a cathode wafer 300 comprising the cathode wafer base 100 of FIG. 13 and a cathode layer 150 attached to the cathode current collector film 130 adjacent the first interposer layer 140. As can be seen in FIG. 19, each of the square openings defined by the first interposer layer 140 are filled with the cathode layer 150. In at least one aspect, the cathode layer 150 comprise a lattice and, in various instances, a micro-lattice. In at least one aspect, the lattice is a three-dimensional open cell lattice comprising a plurality of unit cells defined by a plurality of porous, interconnected, conductive metal, or ceramic trusses. In at least one aspect, the lattice is formed by droplet-based printing having a diameter ranging from 20 μm to 50 μm, periodically-spaced with periodicity ranging from 2 μm to 500 μm per unit cell in an X-dimension, a Y-dimension, and/or a Z-dimension. In at least one aspect, the cathode layer 150 is additively manufactured (e.g., 3D printed) onto the cathode current collector film 130 adjacent the first interposer layer 140, i.e. within the openings defined by the interposer layer 140. In at least one aspect, the cathode layer 150 comprises one of lithium cobalt oxide (LCoO₂), lithium iron phosphate (LFePO₄), lithium nickel manganese cobalt oxide (LiNiMnCoO₂). In at least one aspect, the cathode layer 150 comprises one of tin oxide (SnO₂), lithium manganese oxide (LiMn₂O₄), lithium titanium oxide (Li₂TiO₃), lithium nickel oxide (LiNiO₂), lithium iron phosphate fluoride (Li₂FePO₄F), lithium cobalt nickel manganese oxide (LiCo_{1/3}Ni_{1/3}Mn_{1/3}O₂), Li(LiₐNiₓMn_{y}Co_{z})O₂ silicon, lithium ferrophosphate (LiFePO₄), sulfur, a lithium foil, or combinations thereof.

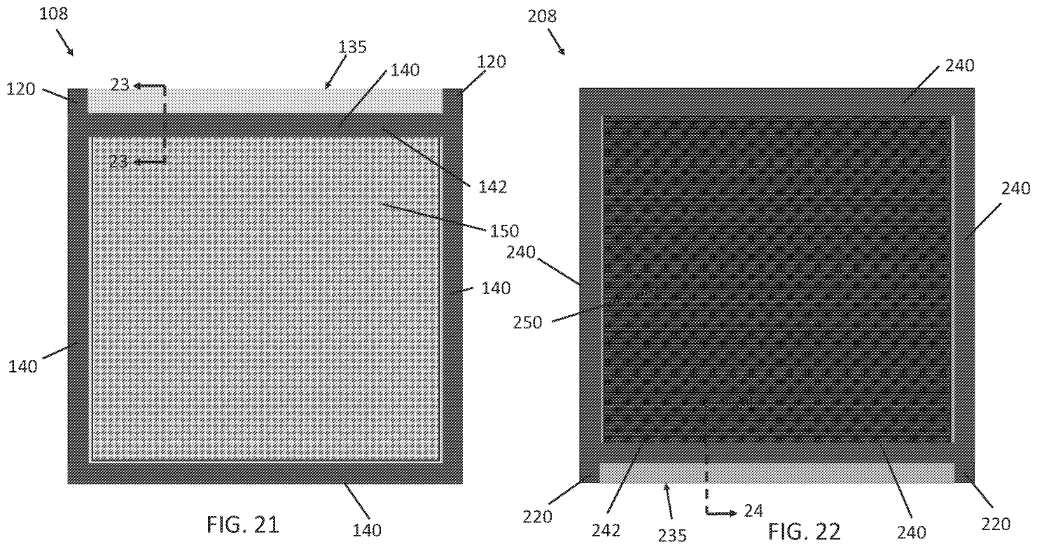

FIG. 20 illustrates an anode wafer 400 comprising the anode wafer base 200 of FIG. 14 and an anode layer 250 attached to the anode current collector film 230 adjacent the second interposer layer 240. As can be seen in FIG. 20, each of the square openings defined by the second interposer layer 240 are filled with the anode layer 250. In at least one aspect, the anode layer 250 comprises graphite. In at least one aspect, the anode layer 250 comprises one of a solid film or a slurry. In at least one aspect, the anode layer 250 comprise a lattice. In at least one aspect, the anode layer 250 comprise a micro-lattice. In at least one aspect, the anode layer 250 is additively manufactured (e.g., 3D printed) onto the anode current collector film 230 adjacent the second interposer layer 240. In at least one aspect, the anode layer 250 comprises silicon. In at least one aspect, the anode layer 250 comprises a transition metal oxide such as F3₃O₄, for example. In at least one aspect, the anode layer 250 comprises a transition metal oxide. In at least one aspect, the anode layer 250 comprises a transition metal sulfide. In at least one aspect, the anode layer 250 comprises a transition metal phosphide. In at least one aspect, the anode layer 250 comprises a transition metal nitride. In at least one aspect, the anode layer 250 comprises a metal alloy such as Germanium, Tin, or a Zin-base alloy, for example. In at least one aspect, the anode layer 250 comprises one or more than one carbon nanotube. In at least one aspect, the anode layer 250 comprises Graphene. In at least one aspect, the anode layer 250 comprises Titanium dioxide. In at least one aspect, the anode layer 250 comprises Lithium Titanate.

In at least one aspect, the cathode layer 150 and/or the anode layer 250 may be similar in many aspects to those described in U.S. Pat. No. 11,817,588 entitled THREE-DIMENSIONAL LATTICE BATTERIES VIA ADDITIVE MANUFACTURING, the entire disclosure of which is hereby incorporated by reference herein in its entirety. For example, the lattice structure and the materials can be similar to those described in U.S. Pat. No. 11,817,588.

FIG. 21 illustrates a cathode die 108 of the cathode wafer 300 of FIG. 19. FIG. 19 illustrates the cathode layer 150 positioned between the four walls of the first interposer layer 140. Further, FIG. 22 illustrates an anode die 208 of the anode wafer 400 of FIG. 20. FIG. 20 illustrates the anode layer 250 positioned between the four walls of the second interposer layer 240. FIGS. 21 and 22 are representative of what the cathode die 108 and the anode die 208 would look like if the cathode die 108 and the anode die 208 were sectioned from their respective wafers 300, 400 at this stage of manufacture.

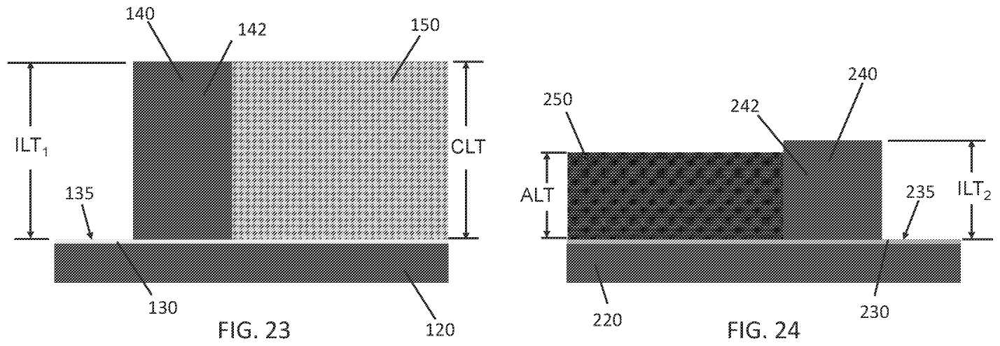

FIG. 23 is a cross section view of FIG. 21 taken along line 23-23 in FIG. 21. FIG. 23 illustrates the cathode layer 150 adjacent to the first interposer layer 140. In at least one aspect, the cathode layer 150 defines a cathode layer thickness CLT. In at least one aspect, the cathode layer thickness CLT is equal to the first interposer layer thickness ILT₁. In at least one aspect, the cathode layer thickness CLT is approximately 450 μm.

FIG. 24 is a cross section view of FIG. 22 taken along line 24-24 in FIG. 22. FIG. 24 illustrates the anode layer 250 adjacent to the second interposer layer 240. In at least one aspect, the anode layer 250 defines an anode layer thickness ALT. In at least one aspect, the anode layer thickness ALT is equal to the second interposer layer thickness ILT₂. In at least one aspect, the ALT is approximately 220 μm.

Further to the above, in various aspect, the cathode layer thickness CLT and the anode layer thickness ALT may be optimized to equalize the energy storage capacity of the battery that will eventually be formed by the cathode die and the anode die. In at least one aspect, the materials selected for the cathode layer 150 and the anode layer 250 will have different energy storage capacities per volume. As such, the thicknesses and/or the volume of the cathode layer 150 and the anode layer 250 may be selected such that the overall energy storage capacity of the formed battery is optimized. In at least one aspect, the cathode layer thickness CLT and the anode layer thickness ALT are different. In at least one aspect, the volume of the cathode layer 150 and the volume of the anode layer 250 are different.

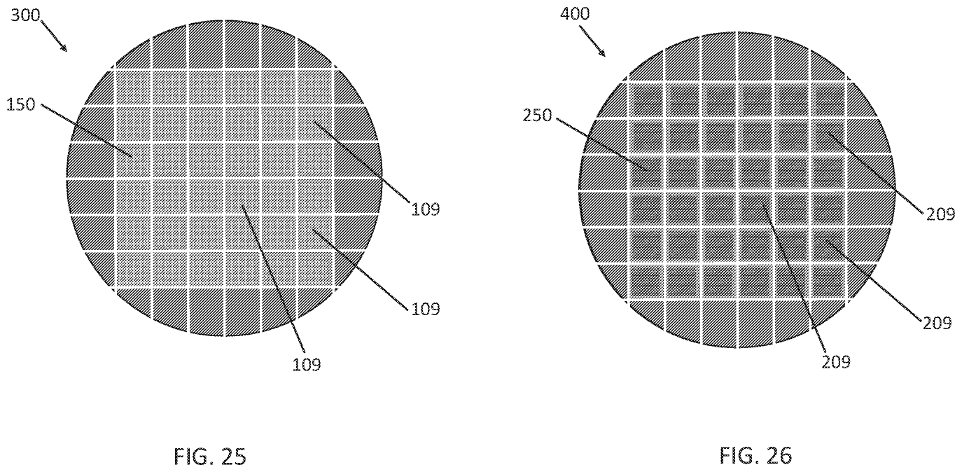

FIGS. 25 and 26 illustrate the cathode wafer 300 and the anode wafer 400 prepared for sectioning (e.g., battery die singulation). In at least one aspect, a dicing tape is applied to the top surfaces of the cathode wafer 300 and the anode wafer 400. In at least one aspect, the dicing tape is low tack dicing tape. In any event, once the dicing tape is applied, the cathode wafer 300 and the anode wafer 400 are sectioned (e.g., diced) into a plurality of individual cathode dies 109 and into a plurality of individual anode dies 209. As discussed previously, in at least one aspect, each wafer 300, 400 may be diced into thirty-six individual dies as shown in FIGS. 25 and 26. In other instances, each wafer 300, 400 can be diced into a different number of dies, which can depend on the size of the wafers 300, 400 and the desired size of the batteries manufactured therefrom. During subsequent processing of the individual dies, the dicing tape may remain in place over the individual dies 109, 209 until the dies are ready for further processing. The tape may be peeled from the dies during subsequent processing.

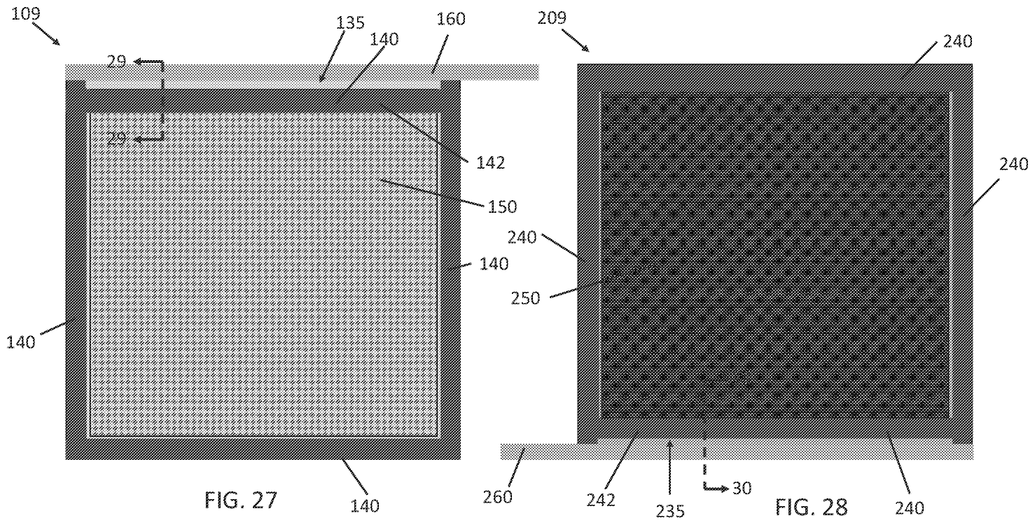

FIG. 27 illustrates one of the individual cathode dies 109 of FIG. 25 further comprising a first conductor 160 attached to the first tab 135 of the individual cathode die 109. In at least one aspect, the first conductor 160 extends beyond the first interposer layer 140, as shown in FIG. 27. Further, FIG. 28 illustrates one of the individual anode dies 209 of FIG. 26, further comprising a second conductor 260 attached to the second tab 235 of the individual anode die 109. In at least one aspect, the second conductor 260 extends beyond the second interposer layer 240, as shown in FIG. 28. In at least one aspect, the conductor 160 comprises a wire. In at least one aspect, the conductor 260 comprises a wire.

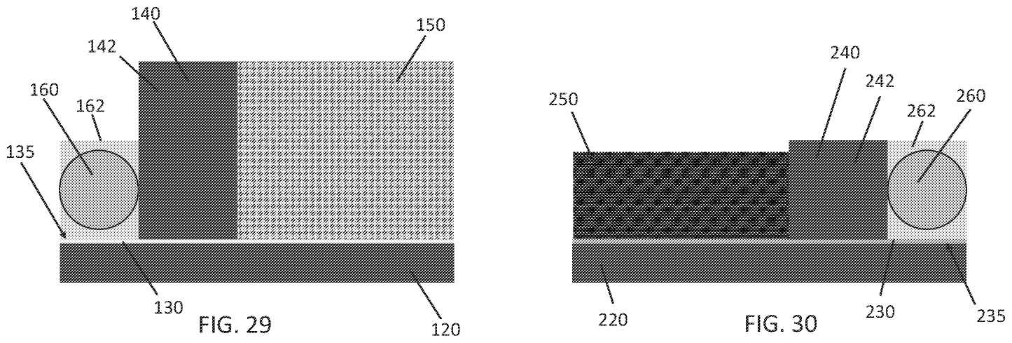

FIG. 29 is a cross section view of FIG. 27 taken along line 29-29 in FIG. 27. FIG. 27 illustrates the first conductor 160 attached to the first tab 135 adjacent to the first interposer layer 140. Further, FIG. 30 is a cross section view of FIG. 28 taken along line 30-30 in FIG. 28. FIG. 30 illustrates the second conductor 260 attached to the first tab 135 adjacent to the second interposer layer 240. Further, in at least one aspect, an indium paste 162, 262 is applied to the first conductor 160 and the second conductor 260 to attach the conductors 160, 260 to their respective tabs 135, 235. In at least one aspect, after the conductors 160, 260 are attached to their respective tabs 135, 235, the individual dies 109, 209 are baked. In at least one aspect, the individual dies 109, 209 are baked at 160° C. In other instances, the dies 109, 209 can be diced at a different temperature than 160° C. depending on the materials thereof, among other factors. In at least one aspect, the conductor 160, 260 are welded or soldered to their respective die 109, 209.

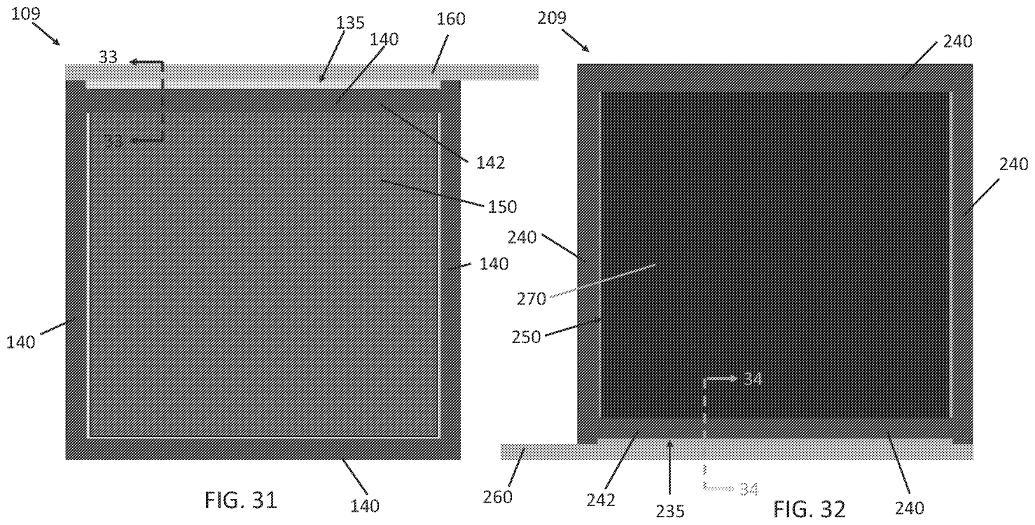

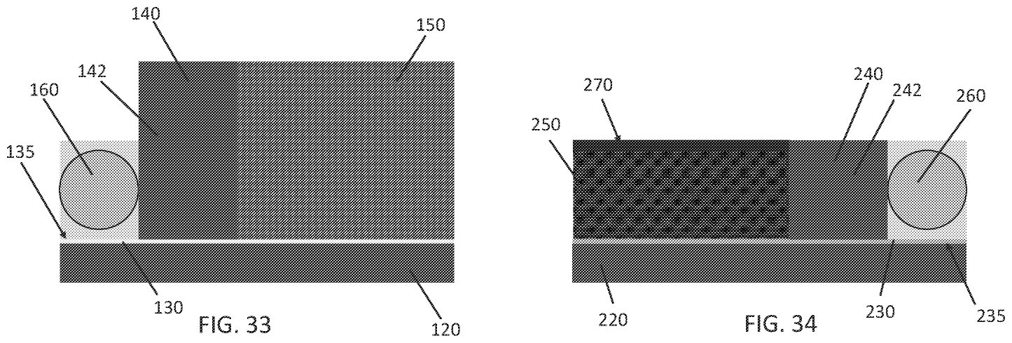

FIGS. 31 and 33 illustrate the cathode layer 150 of the individual cathode die 109 wetted with an electrolyte solution. Further, FIGS. 32 and 34 illustrate the anode layer 250 of the individual anode die 209 wetted with an electrolyte solution. In at least one aspect, the electrolyte solutions comprise LiPF₆ electrolyte. In at least one aspect, a separator layer 270 is applied to the anode layer 250 of the individual anode die 209. The separator layer 270 defines a separator layer thickness ST. In at least one aspect, the separator layer thickness ST is approximately 30 μm. In at least one aspect, the separator layer 270 comprises at least one of polypropylene (PP) and polyethylene (PE). In at least one aspect, the separator layer 270 comprises PP and PE. In at least one aspect, the separator layer 270 comprises a layer of PE sandwiched between two layers of PP. In at least one aspect, the separator layer 270 may be applied to the cathode layer 150 in lieu of being applied to the anode layer 250. In at least one aspect, the separator layer 270 comprises a polymer blend including PP and PE as a single mixture.

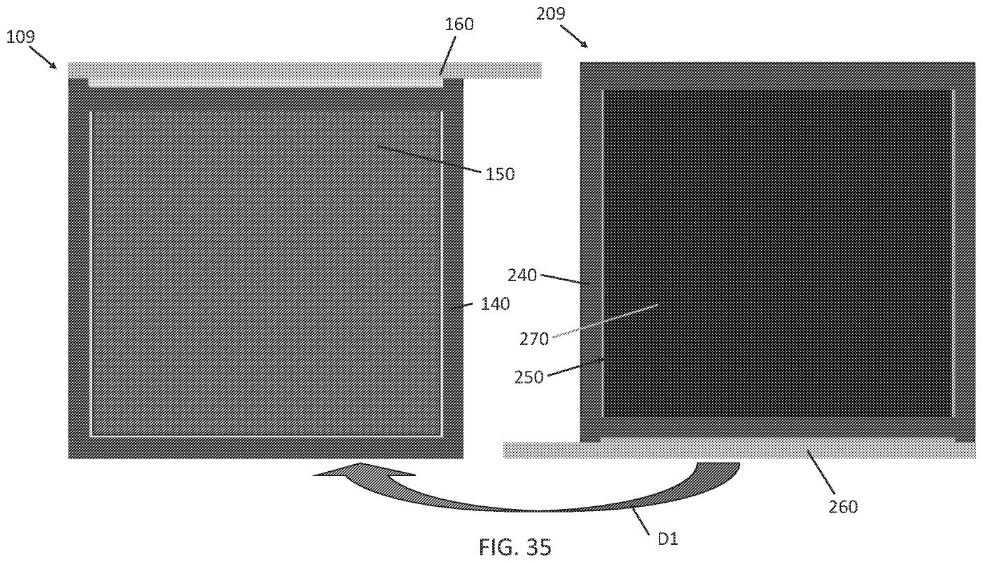

FIG. 35 illustrates an example of the direction D1 in which the individual anode die 209 may be rotated, or flipped, to assemble with the individual cathode die 109. In other words, the anode die 209 may be flipped over 180 degrees to align with the cathode die 109. In at least one aspect, the individual cathode die 109 may be rotated 180 degrees onto the individual anode die 209. In various aspects, any number of orientations may exist between the individual cathode die 109 and the individual anode die 209 prior to bonding the dies 109, 209 together. For example, the cathode die 109 and the anode die 209 may be oriented relative to one another such that the first conductor 160 and the second conductor 260 extend from their respective dies 109, 209 in opposite directions. Further, in at least one aspect, the cathode die 109 and the anode die 209 may be oriented relative to one another such that the first conductor 160 and the second conductor 260 are orthogonal to each other. Further still, in at least one aspect, the cathode die 109 and the anode die 209 may be oriented relative to one another such that at least a portion of the first conductor 160 and at least a portion of the second conductor 260 cross over one another.

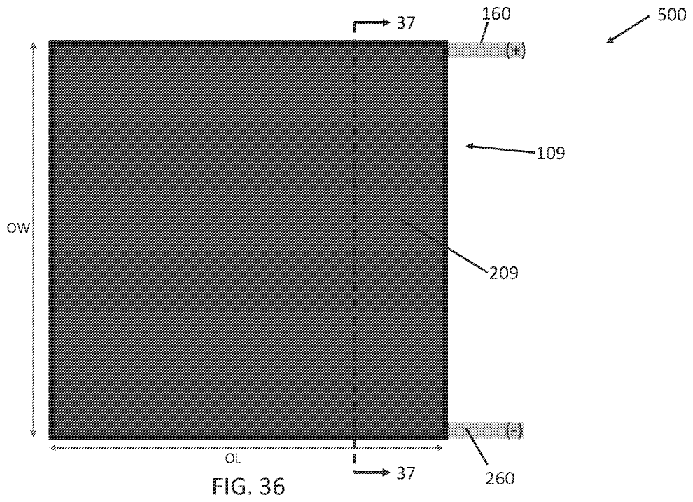

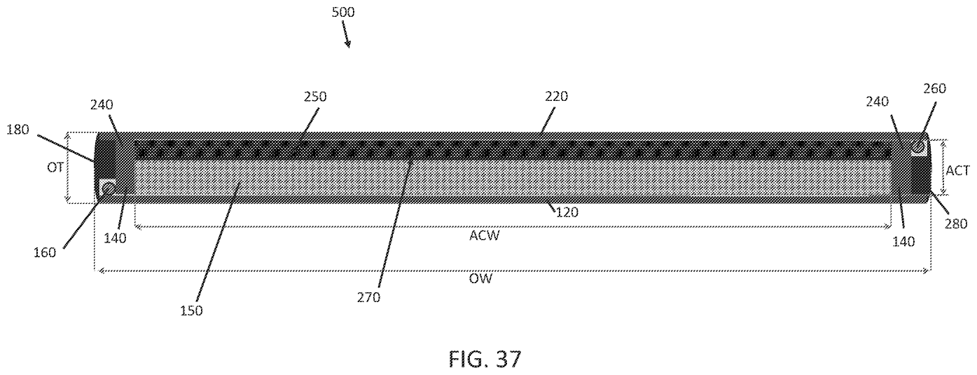

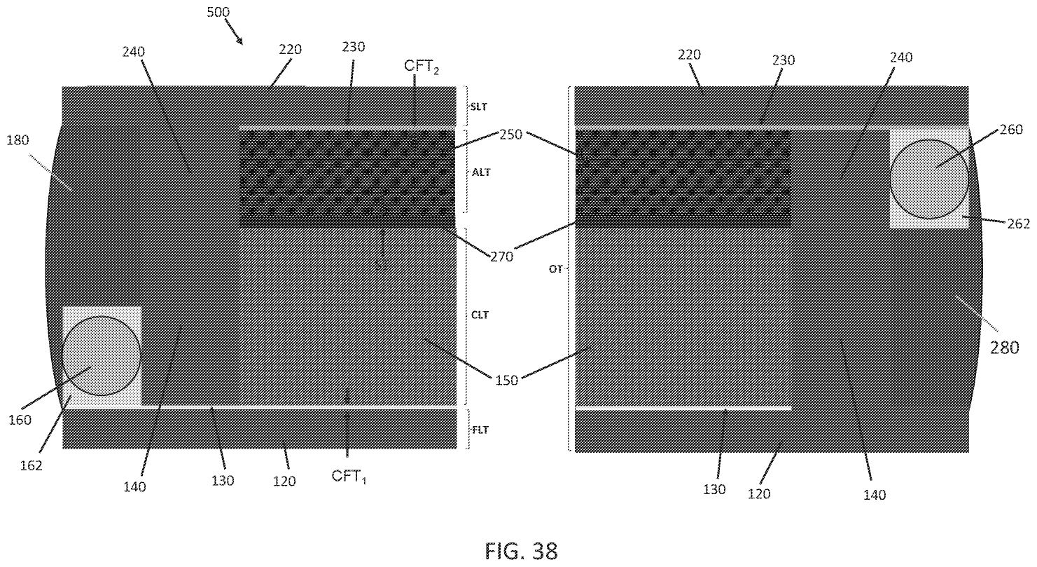

FIG. 36 illustrates the individual cathode die 109 and the individual anode die 209 bonded together to form a battery 500, under one such above mentioned orientation. In various aspects of the present disclosure, the battery 500 is a micro-battery. In at least one aspect, the battery 500 is a micro-battery with a total battery cell volume less than or equal to 100 mm³. In at least one aspect, the battery 500 is a micro-battery with a total battery cell volume less than or equal to 1000 mm³. In various aspects, once the cathode die 109 and the anode die 209 are joined together, a die is used to press down on the edge regions to squeeze out excess electrolyte from the cathode layer 150 and the anode layer 250. Subsequently, the battery 500 may be rinsed with dimethyl carbonate, dried with Nitrogen (N₂), and the perimeter of the battery may be sealed with a vacuum adhesive 180, 280 (see FIGS. 37 and 38). In at least one aspect, the vacuum adhesive comprises Torr Seal.

Further to the above, in FIG. 36, the anode die 209 has been placed on top of the cathode die 109 with the first conductor 160 and the second conductor 260 extending from the battery 500 in the same direction. In at least one aspect, the battery 500 comprises an overall width OW and an overall length OL, as shown in FIG. 36. In at least one aspect, the overall width OW and the overall length OL are equal. In at least one aspect, the overall width OW is approximately 10.54 mm and the overall length OL is approximately 10.54 mm. In at least one aspect, the overall width OW and the overall length OL are not equal to each other.

FIG. 37 illustrates an overall cross section view of the battery 500 taken from FIG. 36. FIG. 38 is an enlarged view of the cross section of FIG. 37 highlighting the edge regions of the battery 500. Referring to FIG. 37, the battery 500 defines an overall thickness OT. In at least one aspect, the overall thickness OT is approximately 0.9 mm. The cathode layer 150 and the anode layer 250 define an active cell thickness ACT. In at least one aspect, the active cell thickness ACT does not include the thickness of the separator layer 270. In at least one aspect, the active cell thickness ACT is approximately 0.7 mm. Further, the cathode layer 150 and the anode layer 250 define an active cell width ACW as shown in FIG. 37. In at least one aspect, the active cell width ACW is approximately 9.64 mm. The cathode layer 150 and the anode layer 250 define an active cell length (not shown). In at least one aspect, the active cell length is approximately 9.64 mm. In at least one aspect, the cathode layer 150 and the anode layer 250 define an active material volume defined by the active cell width ACW multiplied by the active cell length multiplied by the active cell thickness ACT. In at least one aspect, the active material volume is approximately 62 mm³. In at least one aspect, the total volume of the entire battery 500 is 100 mm³. In at least one aspect, the active material volume percentage of the total volume of the battery 500 is approximately 62%.

Further to the above, in at least one aspect, the battery 500 is square in nature (see FIGS. 36-38). However, alternatives to square cathode and square anode dies are contemplated, which would result in a battery profile that is not square. For example, in various aspects, the cathode dies and the anode dies may shapes that are curved, circular, elliptical, etc. to form a curved, circular, elliptical, etc. battery profile.

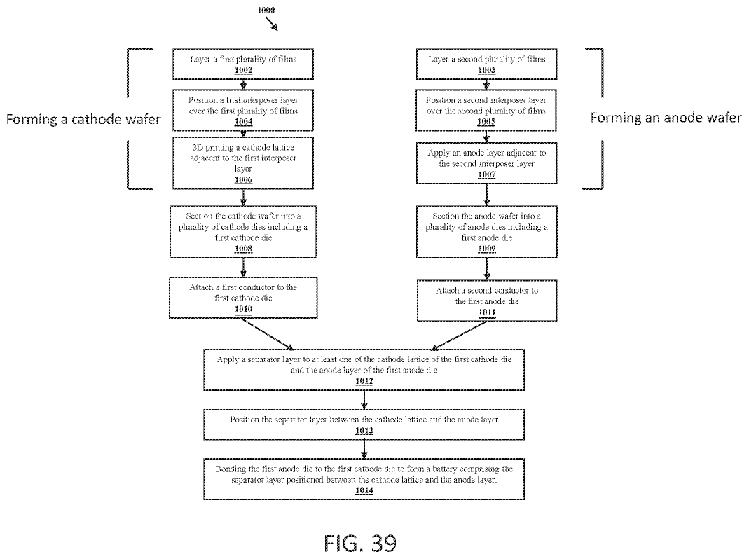

FIG. 39 illustrates a method 1000 of manufacturing a battery, such as the battery 500, in accordance with at least one aspect of the present disclosure. As discussed above, a cathode wafer, such as the cathode wafer 300, and an anode wafer, such as the anode wafer 400 may be formed separately and then sectioned into individual cathode dies and individual anode dies which will be subsequently bonded together to form a plurality of individual batteries. In the method 1000, forming a cathode wafer comprises layering a first plurality of films at step 1002, positioning a first interposer layer over the first plurality of films at step 1004, and 3D printing a cathode lattice adjacent to the first interposer layer at step 1006. Further, in the method 1000, forming an anode wafer 1060 comprises layering a second plurality of films at step 1003, positioning a second interposer layer over the second plurality of films at step 1005, and applying an anode layer adjacent to the second interposer layer at step 1007. Once the cathode wafer 1050 and the anode wafer 1060 are formed, the wafers can be sectioned. For example, the cathode wafer is sectioned into a plurality of cathode dies at step 1008. The plurality of cathode dies includes a first cathode die. Further, the anode wafer 1060 is sectioned into a plurality of anode dies at step 1009. The plurality of anode dies comprises a first anode die. After sectioning of the cathode and anode wafers, a first conductor is attached to the first cathode die at step 1010 and a second conductor is attached to the first anode die at step 1011. The same conductor attachment step can be repeated for all of the sectioned cathode and anode dies. In any event, the method 1000 further comprises applying a separator layer to at least one of the cathode lattice of the first cathode die and the anode layer of the first anode die at step 1012. The method further comprises positioning the separator layer between the cathode lattice and the anode layer at step 1013. The method further comprises bonding the first anode die to the first cathode die to form a battery comprising the separator layer positioned between the cathode lattice and the anode layer at step 1014.

Various aspects of the subject matter described herein are set out in the following numbered examples.

Example 1—A method comprising forming a cathode wafer and forming an anode wafer. Forming the cathode wafer comprises layering a first plurality of films, positioning a first interposer layer over the first plurality of films, and 3D printing a cathode lattice adjacent to the first interposer layer. Forming the anode wafer comprises layering a second plurality of films, positioning a second interposer layer over the second plurality of films, and applying an anode layer adjacent to the second interposer layer. The method further comprises sectioning the cathode wafer into a plurality of cathode dies. The plurality of cathode dies comprises a first cathode die. The method further comprises sectioning the anode wafer into a plurality of anode dies. The plurality of anode dies comprises a first anode die. The method further comprises attaching a first conductor to the first cathode die, attaching a second conductor to the first anode die, applying a separator layer to at least one of the cathode lattice of the first cathode die and the anode layer of the first anode die, positioning the separator layer between the cathode lattice and the anode layer, and bonding the first anode die to the first cathode die to form a battery comprising the separator layer positioned between the cathode lattice and the anode layer.

Example 2—The method of Example 1, wherein a pair of dies comprises a cathode die of the plurality of cathode dies and an anode die of the plurality of anode dies, further comprising, for each pair of dies attaching a first conductor to the cathode die, attaching a second conductor to the anode die, applying a separator layer to at least one of the cathode lattice of the cathode die and the anode layer of the anode die, positioning the separator layer between the cathode lattice of the cathode die and the anode layer of the anode die, and bonding the anode die to the cathode die to form a battery comprising the separator layer positioned between the cathode lattice and the anode layer.

Example 3—The method of Example 1 or 2, further comprising wetting the cathode lattice of the first cathode die with an electrolyte solution prior to bonding.

Example 4—The method of Examples 1, 2, or 3, wherein layering a first plurality of films comprises laminating a biaxially oriented polyethylene terephthalate (BoPET) layer onto a first substrate, and depositing, using e-beam evaporation, an aluminum cathode current collector layer onto the BoPET layer.

Example 5—The method of Examples 1, 2, 3, or 4, wherein layering a second plurality of films comprises laminating a biaxially oriented polyethylene terephthalate (BoPET) layer onto a second substrate, and depositing, using physical vapor deposition (PVD), a copper layer onto the BoPET layer.

Example 6—The method of Examples 1, 2, 3, 4, or 5, wherein forming the cathode wafer further comprises curing the first interposer layer after positioning the first interposer layer over the first plurality of films.

Example 7—The method of Examples 1, 2, 3, 4, 5, or 6, wherein forming the anode wafer further comprises curing the second interposer layer after positioning the second interposer layer over the second plurality of films.

Example 8—The method of Examples 1, 2, 3, 4, 5, 6, or 7, wherein the first cathode die comprises a first tab, and wherein attaching the first conductor to the cathode die comprises welding or soldering the first conductor to the first tab.

Example 9—The method of Examples 1, 2, 3, 4, 5, 6, 7, or 8, wherein the first anode die comprises a second tab, and wherein attaching the second conductor to the anode die comprises welding or soldering the second conductor to the second tab.

Example 10—The method of Example 1, 2, 3, 4, 5, 6, 7, 8, or 9, wherein the volume of the cathode lattice and the volume of the anode layer are not equal.

Example 11—A method comprising forming a cathode wafer and forming an anode wafer. Forming the cathode wafer comprises layering a first plurality of films and 3D printing a cathode lattice. Forming the anode wafer comprises layering a second plurality of films and applying an anode layer. The method further comprises sectioning the cathode wafer into a plurality of cathode dies. The plurality of cathode dies comprises a first cathode die. The method further comprises sectioning the anode wafer into a plurality of anode dies. The plurality of anode dies comprises a first anode die. A pair of dies comprises the first cathode die and the first anode die. The method further comprises assembling a battery with the pair of dies.

Example 12—The method of Example 11, wherein assembling the battery further comprises attaching a first conductor to a first tab of the first cathode die and attaching a second conductor to a second tab of the first anode die.

Example 13—The method of Example 11 or 12, wherein assembling the battery further comprises applying a separator layer to at least one of the pair of dies.

Example 14—The method of Example 13, wherein assembling the battery further comprises bonding the first anode die to the first cathode die, and wherein the separator layer is positioned between the cathode lattice and the anode layer after bonding.

Example 15—A battery comprising a cathode portion, an anode portion, an interposer layer, and a separator layer. The cathode portion comprises a first plurality of film layers, a cathode layer, and a first conductor. The cathode layer comprises a micro-lattice. The anode portion comprises a second plurality of film layers, an anode layer, and a second conductor. The interposer layer extends between the first plurality of film layers and the second plurality of film layers and around the cathode layer and the anode layer. The separator layer is positioned between the cathode layer and the anode layer.

Example 16—The battery of Example 15, wherein the anode layer comprises graphite.

Example 17—The battery of Example 15 or 16, wherein the cathode layer comprises one of lithium cobalt oxide (LCoO₂), lithium iron phosphate (LFePO₄), or lithium nickel manganese cobalt oxide (LiNiMnCoO₂).

Example 18—The battery of Examples 15, 16, or 17 wherein one of the first plurality of film layers and the second plurality of film layers comprises biaxially oriented polyethylene terephthalate (BoPET).

Example 19—The battery of Examples 15, 16, 17, or 18, wherein the cathode layer comprises an electrolyte solution.

Example 20—The battery of Examples 15, 16, 17, 18, or 19, wherein at least one of the anode layer and the cathode layer comprises a 3D-printed layer.

While several forms have been illustrated and described, it is not the intention of the applicant to restrict or limit the scope of the appended claims to such detail. Numerous modifications, variations, changes, substitutions, combinations, and equivalents to those forms may be implemented and will occur to those skilled in the art without departing from the scope of the present disclosure. Moreover, the structure of each element associated with the described forms can be alternatively described as a means for providing the function performed by the element. Also, where materials are disclosed for certain components, other materials may be used. It is therefore to be understood that the foregoing description and the appended claims are intended to cover all such modifications, combinations, and variations as falling within the scope of the disclosed forms. The appended claims are intended to cover all such modifications, variations, changes, substitutions, modifications, and equivalents.

As used in any aspect herein, the terms “component,” “system,” “module” and the like can refer to a computer-related entity, either hardware, a combination of hardware and software, software, or software in execution.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

It will be further appreciated that, for convenience and clarity, spatial terms such as “vertical”, “horizontal”, “up”, and “down” may be used herein with respect to the drawings. However, treatment systems can be used in many orientations and positions, and these terms are not intended to be limiting and/or absolute.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A method, comprising:
forming a cathode wafer, comprising:
layering a first plurality of films;
positioning a first interposer layer over the first plurality of films; and
3D printing a cathode lattice adjacent to the first interposer layer;
forming an anode wafer, comprising:
layering a second plurality of films;
positioning a second interposer layer over the second plurality of films; and
applying an anode layer adjacent to the second interposer layer; and
sectioning the cathode wafer into a plurality of cathode dies, wherein the plurality of cathode dies comprises a first cathode die;
sectioning the anode wafer into a plurality of anode dies, wherein the plurality of anode dies comprises a first anode die;
attaching a first conductor to the first cathode die;
attaching a second conductor to the first anode die;
applying a separator layer to at least one of the cathode lattice of the first cathode die and the anode layer of the first anode die;
positioning the separator layer between the cathode lattice and the anode layer; and
bonding the first anode die to the first cathode die to form a battery comprising the separator layer positioned between the cathode lattice and the anode layer.

2. The method of claim 1, wherein a pair of dies comprises a cathode die of the plurality of cathode dies and an anode die of the plurality of anode dies, further comprising, for each pair of dies:
attaching a first conductor to the cathode die;
attaching a second conductor to the anode die;
applying a separator layer to at least one of the cathode lattice of the cathode die and the anode layer of the anode die;
positioning the separator layer between the cathode lattice of the cathode die and the anode layer of the anode die; and
bonding the anode die to the cathode die to form a battery comprising the separator layer positioned between the cathode lattice and the anode layer.

3. The method of claim 1, further comprising wetting the cathode lattice of the first cathode die with an electrolyte solution prior to bonding.

4. The method of claim 1, wherein layering a first plurality of films comprises:
laminating a biaxially oriented polyethylene terephthalate (BoPET) layer onto a first substrate; and
depositing, using e-beam evaporation, an aluminum cathode current collector layer onto the BoPET layer.

5. The method of claim 1, wherein layering a second plurality of films comprises:
laminating a biaxially oriented polyethylene terephthalate (BoPET) layer onto a second substrate; and
depositing, using physical vapor deposition (PVD), a copper layer onto the BoPET layer.

6. The method of claim 1, wherein forming the cathode wafer further comprises curing the first interposer layer after positioning the first interposer layer over the first plurality of films.

7. The method of claim 1, wherein forming the anode wafer further comprises curing the second interposer layer after positioning the second interposer layer over the second plurality of films.

8. The method of claim 1, wherein the first cathode die comprises a first tab, and wherein attaching the first conductor to the cathode die comprises welding or soldering the first conductor to the first tab.

9. The method of claim 1, wherein the first anode die comprises a second tab, and wherein attaching the second conductor to the anode die comprises welding or soldering the second conductor to the second tab.

10. The method of claim 1, wherein the volume of the cathode lattice and the volume of the anode layer are not equal.

11. A method, comprising:
forming a cathode wafer, comprising:
layering a first plurality of films; and
3D printing a cathode lattice;
forming an anode wafer, comprising:
layering a second plurality of films; and
applying an anode layer;
sectioning the cathode wafer into a plurality of cathode dies, wherein the plurality of cathode dies comprises a first cathode die;
sectioning the anode wafer into a plurality of anode dies, wherein the plurality of anode dies comprises a first anode die, wherein a pair of dies comprises the first cathode die and the first anode die; and
assembling a battery with the pair of dies.

12. The method of claim 11, wherein assembling the battery further comprises:
attaching a first conductor to a first tab of the first cathode die; and
attaching a second conductor to a second tab of the first anode die.

13. The method of claim 11, wherein assembling the battery further comprises applying a separator layer to at least one of the pair of dies.

14. The method of claim 13, wherein assembling the battery further comprises bonding the first anode die to the first cathode die, and wherein the separator layer is positioned between the cathode lattice and the anode layer after bonding.

15. A battery, comprising:
a cathode portion, comprising:
a first plurality of film layers;
a cathode layer comprising a micro-lattice; and
a first conductor;
an anode portion, comprising:
a second plurality of film layers;
an anode layer; and
a second conductor;
an interposer layer extending between the first plurality of film layers and the second plurality of film layers and around the cathode layer and the anode layer; and
a separator layer positioned between the cathode layer and the anode layer.

16. The battery of claim 15, wherein the anode layer comprises graphite.

17. The battery of claim 15, wherein the cathode layer comprises one of lithium cobalt oxide (LCoO₂), lithium iron phosphate (LFePO₄), or lithium nickel manganese cobalt oxide (LiNiMnCoO₂).

18. The battery of claim 15, wherein one of the first plurality of film layers and the second plurality of film layers comprises biaxially oriented polyethylene terephthalate (BoPET).

19. The battery of claim 15, wherein the cathode layer comprises an electrolyte solution.

20. The battery of claim 15, wherein at least one of the anode layer and the cathode layer comprises a 3D-printed layer.
